(19) United States
(12) Patent Application Publication
(10) Pub. No.: US 2016/0045905 A1
(43) Pub. Date: Feb. 18, 2016

(54) APPLICATION OF METHYL CELLULOSE ON WASHCOATS AND PRECIOUS METAL SOLUTION

(71) Applicant: Umicore AG & CO. KG, Hanau (DE)

(72) Inventors: Marco ROBLES, TULSA, OK (US); John GINGERICH, Collinsville, OK (US)

(21) Appl. No.: 14/457,730

(22) Filed: Aug. 12, 2014

(51) Int. Cl. B01J 31/06; B01J 37/02; B01J 35/04

(52) U.S. Cl. CPC B01J 31/06; B01J 35/04; B01J 37/0215

(57) ABSTRACT

The present invention relates to a novel washcoat composition, a method for coating substrates with the washcoat composition and a method for controlling the shelf life of washcoat.

In the production of catalysts for car exhaust systems, monolithic supports are provided with a catalyst mixture in order to enable for the purification of the waste gases of combustion engines.

It is well known in the field of combustion engines that fuel combustion is not complete and yield emissions of pollutants like unburned hydrocarbons (HC), carbon monoxide (CO), nitrogen oxides (NOₓ) and particulate matter (PM). In order to improve air quality, emission limit legislations are in place to achieve lower emissions of pollutants from stationary applications and from mobile sources. For mobile sources like passenger cars, primary measures enabled achieving decrease in the emission of pollutants. Improvement of fuel-air mixing as primary measure yielded considerable diminution of pollutants. However, due to more stringent legislations over the years, the use of heterogeneous catalysts has been made inevitable.

Such supports often are cylindrical support bodies, each having two end faces, a circumferential surface and an axial length L, further being traversed from the first end face to the second end face by a multiplicity of channels. Such support bodies are often also referred to as honeycomb bodies. In particular, the substrates can be flow-through honeycomb bodies or monoliths but also wall-flow-filters. They can be made of different ceramic or metallic materials like cordierite, silicon carbide, steel and the like.

There are several methods to coat the inside of the channels of such honey-combs with a catalyst mixture. Most of these methods employ a liquid slurry component (the washcoat) that is either provided through the top or bottom of the monolithic support by application of increased or decreased pressure in order to press or suck the washcoat into the monolithic support, and thus to coat the inside of the channels with the washcoat. Afterwards, the coated monolithic support is dried and subjected to at least one heat treatment (“calcination”).

One common method is the application of the washcoat on the top of the support and then applying suction or pressure to force the washcoat into the channels of the support. Such a process is described e.g. in U.S. Pat. No. 7,147,892.

When the washcoat is supplied through the top of the monolithic support, several of the problems associated with this method are caused by the washcoat being drawn into the monolithic support prematurely, i.e. before suction or pressure is applied, causing irregular distribution of the washcoat into the protrusions of the support. This problem can be addressed, for example, by sophisticated equipment to overcome this problem. Such an apparatus is disclosed in U.S. Pat. No. 7,323,054.

Another way to overcome this problem is to modify the washcoat in such a way as to increase its viscosity either by increasing the solid content, or adding a gelling agent, like guar gum or synthetic polymers, or both. However, there are several problems caused by this way of overcoming the above problem. First, the rheological behavior of the washcoat changes when the composition is modified in this way so that the thickness of the coating inside the channels tends to become irregular upon coating. The presence of a gelling agent may also impair the processing during heat treatment due to ash formation. Additionally, a washcoat comprising such a gelling agent exhibits a limited shelf life of about one week and does not keep its properties over an, preferably, unlimited time.

It was an object of the invention to provide a novel washcoat composition with extended shelf life, improved rheological behavior to provide for a more constant thickness of the coating that does not show significant ash formation upon heat treatment. This problem was solved by a washcoat composition consisting of a water-based solvent, a catalyst composition and 0.2 to 8 weight percent of a cellulose derivative as a gelling agent.

According to the invention, the gelling agent is a cellulose derivative preferably selected from the group consisting of methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxy methylcellulose, and mixtures thereof, with methylcellulose, hydroxypropyl methylcellulose and mixtures thereof being particularly preferred. The gelling agent according to the invention is present in an amount of 0.2 to 8 weight percent, based on the amount of the total washcoat, preferably 0.5 to 5 weight percent, in particular 2 to 4 weight percent or 2 to 3 weight percent. One embodiment of the invention concerns a washcoat composition consisting of a water-based solvent, a catalyst composition and 0.2 to 8 weight percent of a cellulose derivative as a gelling agent, with the proviso that when the gelling agent is methylcellulose, this gelling agent is present in an amount of more than 0.3, preferably at least 0.5 weight percent, in particular at least 1 weight percent.

The water-based solvent can be water, in particular distilled or demineralized water. If desired, at least one acidic and/or basic compound can be present in order to adjust the pH value, which can be done by the water-based solvent comprising a buffer, or just adding an acidic or a basic compound. It can be particularly preferred that with hydroxypropyl methylcellulose it becomes possible to initiate the gelling process simply be adjusting the pH-value in the washcoat slurry above 8.2-8.7, preferably at 8.5. The same should be possible for all other hydroxy alkyl cellulose derivatives mentioned above. On the other hand, methyl cellulose itself is gelling on heating the washcoat slurry up to 70° C., preferably up to 60° C. and most preferably up to 50° C. without the need to adjust the pH. Same holds true for all alkyl cellulose derivatives mentioned above. The gelling is thus independent from establishing a certain pH-value within the washcoat. The latter is especially advantageous in view of the fact that the pH can be kept in the optimum range for the constituents in the washcoat when initiating the gelling process.

The pH-value of the final slurry is strongly dependent on the constituents present therein. Generally, a stable gel could be obtain within pH of 11-2, preferably between 9 and 4, most preferably around neutral. In view of precious metal solutions that are to be stabilized the pH may be lower at around 4-2, preferably about 3-2.

More specifically, these acidic and/or basic compounds that in combination may form a buffer are organic compounds. Such compounds preferably are volatile and will evaporate when the coated monolithic support is dried, like acetic acid, formic acid or pyridine, or is a non-volatile organic compound that will be decomposed upon further heat treatment. These acidic or basic compounds can be present in an amount of up to 2 weight percent. They can be selected from selected from formic acid, acetic acid, pyridine, pyrimidin, trialkylamine, triarylamines and derivatives or mixtures thereof, or other suitable compounds.

The washcoat according to the invention is employed in a method of coating a monolithic support, comprising the steps of (a) locating a containment means on top of a support, (b) dosing a pre-determined quantity of a washcoat composition into said containment means, either in the order (a) then (b) or (b) then (a), and (c) by applying pressure or vacuum, drawing said washcoat composition into at least a portion of the support, and retaining substantially all of said quantity within the support.

In a preferred method, vacuum is applied to the bottom of the support, causing air pressure to force the liquid component from the containment means into the support. Usually, this method is used for the coating of catalyst or absorber supports. The invention also relates to a catalyst comprising a support coated by the method of the invention.

The present invention also provides a method for controlling the shelf life of a washcoat for catalytic applications by using a gelling agent, wherein said gelling agent is a cellulose derivative as depicted above. It is especially preferred that the shelf life of the washcoat can be prolonged to be more than 1 week, preferably more than 2 weeks and most preferably more than 3 weeks at ambient temperatures. As ambient temperatures those are envisaged which are between 5-20° C., preferably 8-15° C., and most preferably 10-12° C. It is stipulated that the preferred aspects for the gelling agent mentioned above apply likewise to the advantageous use.

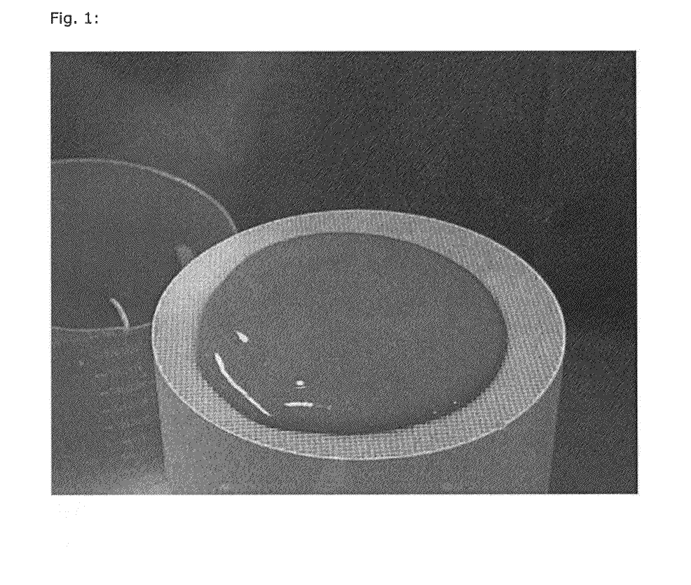

FIG. 1 shows a washcoat rheologically modified with methylcellulose in water on top of a honeycomb monolith.

### EXAMPLES

### Preparation of Precious Metal (PM)/Washcoat (WC) Gel Solution

### Methyl Cellulose (Standard MC)

Methyl Cellulose powders have a viscosity that is specified at 2% wt in water. Add 2 grams of MC powder to 100 mL of water at or above 60 degrees C.

Mix slowly until well distributed and let solution cool down while mixing slowly (to prevent air being trapped while gelation occurs).

Solution will increase in viscosity as it cools down to room temperature. Mix for 20 minutes for homogeneous gelation. Once the mixture is complete it may be used or stored.

### Hydroypropyl Methyl Cellulose (Dow Methocel J5M S)

Add 2 grams of 35M to 100 mL of water at room temperature below pH of 8.5.

Mix slowly until well distributed.

Add base (TMAOH) until pH is above 8.5 (gelation begins).

Continue mixing for 20 minutes for homogeneous gelation. Once mixture is complete it may be used or stored.

NOTE: J5M S is surface treated to be pH activated. Once gelation is achieved through pH, it will behave like standard MC. Standard MC decreases in viscosity with increase in temperature.

### Addition of PM Solution

Pour in PM solution into MC gel.

Maintain pH above 2. Methyl Cellulose breaks apart below a pH of 2, affecting adhesion.

### Addition to WC Slurry

Add MC gel to WC slurry until it reaches adequate viscosity.
Stable between pH of 2 and 11
Viscosity decreases with increasing temperature

Table 1 depicts several trials of coating using solely a water based washcoat and a washcoat that was thickened with 2 wt.-% methylcellulose (MC) in WC. As can be seen the deviations from trial to trial are much lower with the usage of MC compared to without.

TABLE 1

| | Water | | | MC | |
|---|---|---|---|---|---|
| | Reading | Diff | | Reading | Diff |
| 1 | 140.06 | 0.546 | | 141.48 | −0.187 |
| 2 | 139.05 | −0.464 | | 141.53 | −0.137 |
| 3 | 139.86 | 0.346 | | 141.54 | −0.127 |
| 4 | 139.52 | 0.006 | | 141.5 | −0.167 |
| 5 | 139.88 | 0.366 | | 141.73 | 0.063 |
| 6 | 139.6 | 0.086 | | 141.77 | 0.103 |
| 7 | 139.35 | −0.164 | | 141.83 | 0.163 |
| 8 | 139.64 | 0.126 | | 141.84 | 0.173 |
| 9 | 139.06 | −0.454 | | 141.77 | 0.103 |
| 10 | 139.12 | −0.394 | | 141.68 | 0.013 |
| RANGE | 1.01 | | RANGE | 0.360 | |
| STDEV | 0.3619 | | STDEV | 0.1413 | |
| AVERAGE | 139.514 | | AVERAGE | 141.667 | |
| S/N | 51.72 | | S/N | 60.02 | |

1. A washcoat composition consisting of 15 to 55 weight percent of a catalyst composition, 0.2 to 8 weight percent of a gelling agent, the balance being a water-based solvent mixture, wherein the gelling agent is a cellulose derivative.

2. The washcoat composition of claim 1, the cellulose derivative being selected from the group consisting of methylcellulose, ethylhydroxy ethylcellulose, hydroxybutyl methylcellulose, hydroxymethylcellulose, hydroxypropyl methylcellulose, hydroxyethyl methylcellulose, hy-droxybutylcellulose, hydroxyethylcellulose, hydroxypropylcellulose, sodium carboxy methylcellulose, and mixtures thereof.

3. The washcoat composition of claim 1, the gelling agent being present in an amount of 0.5 to 5 weight percent, preferably 1 to 4 weight percent or 2 to 3 weight percent.

4. The washcoat composition of claim 1, wherein the water-based solvent mixture consists of water and up to 2 weight percent of at least one acidic and/or basic compound.

5. The washcoat composition of claim 4, wherein the at least one acidic or basic compound is an organic acid and/or base.

6. The washcoat composition of claim 5, wherein the at least one acidic or basic compound is selected from formic acid, acetic acid, pyridine, pyrimidin, trialkylamine, triarylamines and derivatives or mixtures thereof.

7. A method of coating a monolithic support, comprising the steps of (a) locating a containment means on top of a support, (b) dosing a pre-determined quantity of a washcoat composition into said containment means, either in the order (a) then (b) or (b) then (a), and (c) by applying pressure or vacuum, drawing said washcoat composition into at least a portion of the support, and retaining substantially all of said quantity within the support, wherein the washcoat composition is a composition of claim 1.

8. A method of claim 7, wherein vacuum is applied to the bottom of the support, causing air pressure to force the liquid component from the containment means into the support.

9. A method of claim 7, used for the coating of catalyst or absorber supports.

10. A catalyst comprising a support coated by the method of claim 7.

11. Method for controlling the shelf life of a washcoat tor catalytic applications by using a gelling agent, wherein said gelling agent is a cellulose derivative.
